(19) United States
(12) Patent Application Publication
(10) Pub. No.: US 2024/0046789 A1
(43) Pub. Date: Feb. 8, 2024

(54) CHAYCE-IT Emergency Vehicle Warning System

(71) Applicant: David Chayce Lewing, Henderson, NV (US)

(72) Inventor: David Chayce Lewing, Henderson, NV (US)

(73) Assignees: David Chayce Lewing, Henderson, NV (US); Michelle Leblanc Scott, Henderson, NV (US); Falynne Michelle Lewing, Henderson, NV (US)

(21) Appl. No.: 18/485,226

(22) Filed: Oct. 11, 2023

(51) Int. Cl. G08G 1/0965; G08G 1/16; G01S 17/931; H04W 4/46; H04B 7/155

(52) U.S. Cl. CPC G08G 1/0965; G08G 1/162; G01S 17/931; H04W 4/46; H04B 7/155

(57) ABSTRACT

The Emergency Vehicle Alert Transceiver Broadcast System (EVATBS), referred to as “CHAYCE-IT” via trademark number 98219175, “contains a device that alerts motorists, medical personnel, and pedestrians within a designated radius that an emergency/first responder vehicle (ambulances, fire trucks, police vehicles, and other first responder vehicles) is active within the area. “CHAYCE-IT” uses wireless networking technologies, a lidar or LiDAR system, a Global Positioning System (GPS), and other in-vehicle technologies to provide alert notifications of emergency vehicles to nearby transportation vehicles, commuter vehicles, automobiles, and other emergency vehicles consisting of information such as the active emergency vehicle's exact location, the number of nearby emergency vehicles, general direction, GPS location information, and an estimated distance of active emergency vehicles from receiving vehicles for the purpose of warning motorists to pullover from the road to a safe location. Warning messages from emergency vehicles are displayed within a receiving vehicle through in-vehicle user interfaces.

### BACKGROUND OF THE INVENTION

The main scope of the invention refers to the numerous accidents that occur between civilian vehicles and emergency vehicles as well as accidents that occur between emergency vehicles and other emergency and first responder vehicles due to outdated or insufficient communication methods. In the event of emergency personnel trying to reach individuals with a medical emergency, first responders must navigate the roadways with sirens and flashing lights activated which are intended to warn motorists and people outside of a vehicle ahead of time that emergency vehicles are heading towards an emergency. Although the current methods of warning people through emergency flashing lights and sirens should cause people to become alert, motorists commonly do not hear emergency sirens and see flashing lights. Alternatively, motorists will react to emergency vehicles too late because of various distractions caused by driving or other factors. The result is that emergency personnel and civilians can become caught off guard or react to the impending hazard too late which can present dangerous or life-threatening situations for civilians, emergency personnel, and patients aboard the ambulance. Additional obstructions that can prevent vital communication between emergency and civilian vehicles include obstacles caused by traffic, intersections, in-vehicle distractions such as sound systems, accompanying occupants, or other distractions. Numerous incidents in which drivers and pedestrians are caught off guard by oncoming emergency vehicles are very common occurrences and fatal accidents are numerous among commuter vehicles, transportation vehicles, and other emergency vehicles. The disclosure relates itself to emergency vehicles, first responder vehicles, transportation vehicles, commuter vehicles, and automobile safety in the fields of wireless communications, radio frequency transmission, radio frequency detection, lidar technologies, and predictive warning technologies. The purpose of the disclosed technologies is to provide early warnings to as many vehicles equipped with a transceiver module as possible. Vehicles equipped with a transceiver and a computer processor can detect the proximity of the lidar communication field sent out by emergency vehicles. Detection of the distinctly calibrated lidar signal triggers an alert warning to other transceivers and other devices capable of operating within a wireless or cellular network.

The resulting factors indicate that accidents and collisions among emergency vehicles or civilian vehicles are commonplace on the road with an estimated rate of 5,000 accidents among emergency vehicles and civilian vehicles taking place each year. Medical personnel and civilians demand a new safety feature that rectifies the interference of the conveyance of emergency warnings from emergency vehicles to civilians, medical personnel, and firefighter vehicles. People also demand that the safety feature provide every party with early warnings through a reliable communication relay and reception system inside their automobiles or on their personal mobile devices.

Various systems or procedures have been developed, tested, and evaluated throughout recent years and have failed to be fully implemented into roadway networks, transportation vehicles, or automobiles due to overly high costs, the time to implement such technologies, infrastructure, and technologies that various entities have attempted to implement. Such examples provided by entities, organizations, and companies are a unified network of automobiles that receive warnings through Direct Short-Range Communications (DSRC) or cellular communications technologies. Technologies such as DSRC have since become outdated due to the implementation of 5G cellular networks in many countries across the world which causes sizeable interferences, interruptions, or distortions in the vital communication of warning signal transmission and reception among vehicles, transportation vehicles, commuter vehicles, automobiles, and emergency vehicles alike.

In addition to everything communicated, the invention will be a standardized feature for every automobile from the make, model, year, and vehicle type. Conclusively, each automobile manufacturer will have the option of utilizing the invention for each of their vehicles and provide availability across their vehicle portfolio which can also include commercial vehicle companies, third-party organizations and organizations as well as emergency services, medical, and first responder entities which have access to emergency vehicles.

### SUMMARY OF THE INVENTION

The disclosed invention rectifies and improves communication among emergency vehicles, transportation vehicles, commuter vehicles, automobiles as well as personal mobile devices. The technological invention, the Emergency Vehicle Alert Transceiver Broadcast System (EVATBS) can create a communication field among multiple vehicles of various types within a specific area. A Global Positioning System (GPS) that works together with lidar technologies can integrate into emergency vehicles capable of emitting emergency signals such as flashing lights and sirens. An emergency vehicle emits a communication field through lidar technologies when warning lights and sirens are activated. Mechanical controls that activate the emergency flashing lights, emergency siren, and GPS-lidar system can be interconnected and automatic modules, or, depending on the type of emergency vehicle, can be separately controlled mechanical modules. The invention's GPS and lidar-based system provides warning information to nearby vehicles equipped with an onboard computer processor and a GPS-lidar transceiver module details information regarding approaching active emergency vehicles. Additionally, the disclosed invention (EVATBS or “CHAYCE-IT”) can also provide vehicle occupants of the receiving vehicle a plurality of details about emergency vehicles that can range from the type of emergency vehicle sending the emergency communication signal, the street the vehicle is located on, an estimated distance of emergency vehicles in comparison to the receiving vehicles, and the number of active emergency vehicles within a given area.

Among the currently disclosed details and features of the invention thus far, the disclosed invention can also provide its users with insurance or banking benefits as incentivization for keeping EVATBS active through an onboard telematics module. The telematics module can be an integrated or separately connected sub-component of the invention; it can collect data such as the number of times the transceiver module of the invention detects emergency signals of emergency vehicles as well as the number of times the transceiver module within the integrated vehicle activates. Vehicles and other receiving specimens of emergency signals such as emergency vehicles, transportation vehicles, commuter vehicles, automobiles, personal mobile devices, and the invention's mobile device application also benefit from insurance and banking incentives.

The invention can also receive updates, alterations, enhancements, or modifications through integrated wireless networking technology that can include, for example, a cellular network, a cloud-based network, a wireless local area network, or other wireless network alternatives such as near-field communication. Future enhancements to the functionality of the invention's features and functions can be accomplished through wireless networking and cloud services integrated with the disclosed invention's main components and systems.

### BRIEF DESCRIPTION OF FIGURES

Now, each of the following figures will be explained with reference to the detailed embodiments of the disclosure including all disclosed elements, illustrations, demonstrations, and instructions.

FIG. 1 illustrates a flow diagram of the alert transceiver system in an emergency vehicle communicating with other emergency vehicles, transportation vehicles, commuter vehicles, as well as automobiles within the proximity area.

FIG. 2a illustrates a flowchart of the architecture and process of an emergency vehicle transceiver system which provides nearby vehicles such as vehicles, transportation vehicles, commuter vehicles, and automobiles as well as personal mobile devices, and can also receive emergency signals from other active emergency vehicles.

FIG. 2b illustrates a flowchart of the architecture and process of a vehicle receiving an alert signal via a transceiver module located within a vehicle, transportation vehicle, commuter vehicle, and automobile and providing an alert signal message through various in-vehicle system displays.

FIG. 3a represents block diagrams that illustrate a user interface or gauge cluster system within a commuter vehicle or automobile displaying alert signal information designed to inform vehicle occupants that emergency vehicles are heading in the receiving vehicle's direction which also includes the type of emergency vehicle, general direction, and the estimated amount of active emergency vehicles within the receiving vehicle's area.

FIG. 3b presents block diagrams that further highlight alert signal contents displayed through a user interface or gauge cluster display as it relates to the estimated amount of active emergency vehicles, the emergency vehicle's distance in relation to the receiving vehicle, and the name of the street the emergency vehicles are located.

FIG. 3c highlights a block diagram that illustrates the final alert signal information screen displayed in the user interface or gauge cluster display which communicates to vehicle occupants that the receiving vehicle of the alert signal has cleared all emergency vehicles in the area.

FIG. 4a highlights block diagrams that illustrate alert signal information displayed through a user interface or infotainment display which includes the type of emergency vehicle, the general direction of the emergency vehicle, and the estimated amount of active emergency vehicles within the receiving vehicle's vicinity.

FIG. 4b highlights block diagrams that illustrate a user interface or infotainment system providing vehicle occupants warning signal information which includes the distance of emergency vehicles in relation to the receiving vehicle, the street location, the type of emergency vehicle, and the general direction.

FIG. 4c highlights a block diagram that illustrates a user interface or infotainment system communicating to vehicle occupants that their vehicle has cleared all emergency vehicles in the area.

FIG. 5a highlights a block diagram that illustrates a user interface or heads-up display that provides warning signal information to vehicle occupants about approaching active emergency vehicles that include the general direction, emergency vehicle type, and the estimated amount of active emergency vehicles within the receiving vehicle's vicinity.

FIG. 5b highlights a block diagram that illustrates a user interface or heads-up display system that provides the street name of the emergency vehicle's location, the emergency vehicle's distance in relation to the receiving vehicle, the number of emergency vehicles in the vicinity, and the general location of emergency vehicles.

FIG. 5c highlights a block diagram that illustrates a user interface or heads-up display system communicating to vehicle occupants that the receiving vehicle has cleared all emergency vehicles in the area.

FIG. 6 highlights a flow chart of a banking and insurance telematics module integrated within a vehicle or automobile receiving device activation data based on the number of times the disclosed subject matter is activated.

FIG. 7 highlights a flowchart that further illustrates the architectural framework of the banking and insurance telematics module within a vehicle or automobile as it relates to insurance and banking incentives.

FIG. 8 highlights a flow diagram of a cloud-based computing system that provides software updates to the disclosed invention.

FIG. 9 highlights a flow diagram of personal mobile devices capable of connecting with a wireless network to receive warning signals from oncoming active emergency vehicles and communicate warning signal information to users.

FIG. 10a represents a flow diagram of an emergency vehicle transceiver producing a lidar communication field that can be automatically adjusted according to the emergency vehicle's speed of travel or GPS location.

FIG. 10b further illustrates the procedures of an auto-adjusting lidar communication field in the event of an emergency vehicle changing its speed or location.

### DETAILED DESCRIPTION OF FIGURES

All embodiments disclosed in this document are included and present. The examples shown in the disclosures intend to serve as a demonstration, guidance, and instruction of the functionality, processes, methods, and designs of the intended operation of the disclosed embodiments of the invention. The current disclosure presents itself to demonstrate the features of the disclosed invention in communicated terms that do not limit the invention and its scope. Furthermore, the embodiments shown in this disclosure intend to serve as a demonstration, illustration, model, or specimen, and they are not bound by any expressed theory that exceeds the disclosed scope and design of this disclosure. All communicated operational and functional details or methods are also non-limiting. Additionally, all equivalents, structures, and acts also do not limit the scope of the disclosed embodiments. Enhancements, modifications, and extensions to the invention that are not explicitly disclosed or explained in this document can be possible at the legal discretion of the inventor or owner.

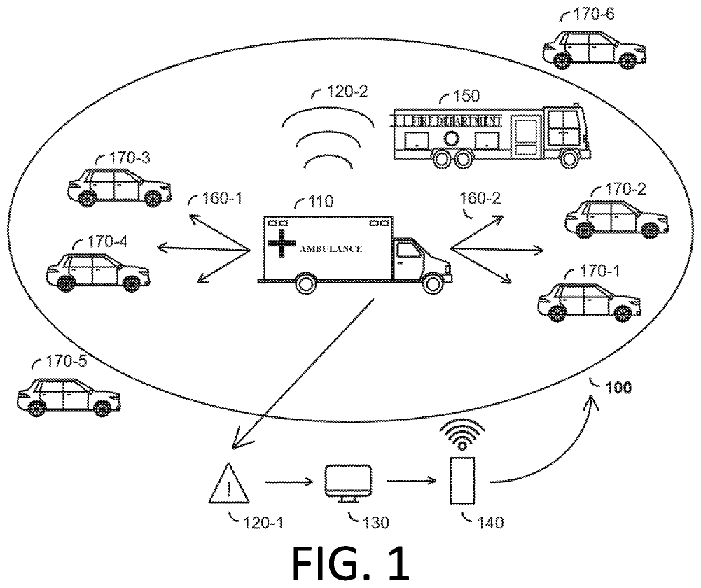

All verbiage communicated to explain certain features, functions, and processes of the invention in the coming figures serves to elaborate the disclosed design or provide further visualization to readers of the document. The expressed way the document is communicated explains that the disclosed invention functions for a specific purpose in an explicit but also non-limiting manner. For instance, in reference to FIGS. 1 through 10, the emergency sirens or flashing lights, also referred to as the “ESM” module, can be interpreted as communicated terms that readers of the document can understand more easily without infringement or alteration to the device's original purpose or function outside of its intended usage and design by its original inventor. In another embodiment, in-vehicle systems such as the in-vehicle UI system (the system vehicle occupants use to interact with the various in-vehicle functions and features such as the infotainment system display), mentioned through the document serve as illustration or demonstration for the functionality and integration of the main invention with the in-vehicle systems and is not meant to be interpreted by readers to consider as anything outside of the specimen's original design, intention, and purpose.

The following diagrams and illustrations will have explanations in accordance with the disclosed embodiments and highlight in detail the designs, purposes, and processes of the main disclosed invention, but they will not serve as limitations to the invention's scope and potential or have other implications beyond the disclosed intentions of the specimen in this document. Future functions and processes implemented in the main disclosed invention can be added by authorized individuals in the passage of time under the legally granted permission and guidance of the inventor.

FIG. 1 illustrates a flow diagram of the alert transceiver system in an emergency vehicle generating a communication field to other emergency vehicles, transportation vehicles, commuter vehicles, as well as automobiles within the proximity area.

FIG. 1 highlights an emergency vehicle(s) 110 emitting an alert signal to nearby vehicles 170-1 . . . 170-6 through a lidar communication field 100 generated by the GPS-lidar system (GPS-LS) 140, as illustrated in the disclosure. The lidar communication field 100 can be activated by the controller of the invention the emergency signal mechanism (ESM) 120-1 which is traditionally utilized to alert pedestrians and motorists of an imminent emergency by emergency flashing lights and a siren. A given input to the ESM 120-1 is processed through the emergency vehicle's 110, 150 onboard computer processor 130, which then triggers the GPS-LS 140 to generate an alert signal to any surrounding vehicles located within proximity of the emergency vehicle's 110 or 150 communication field 100.

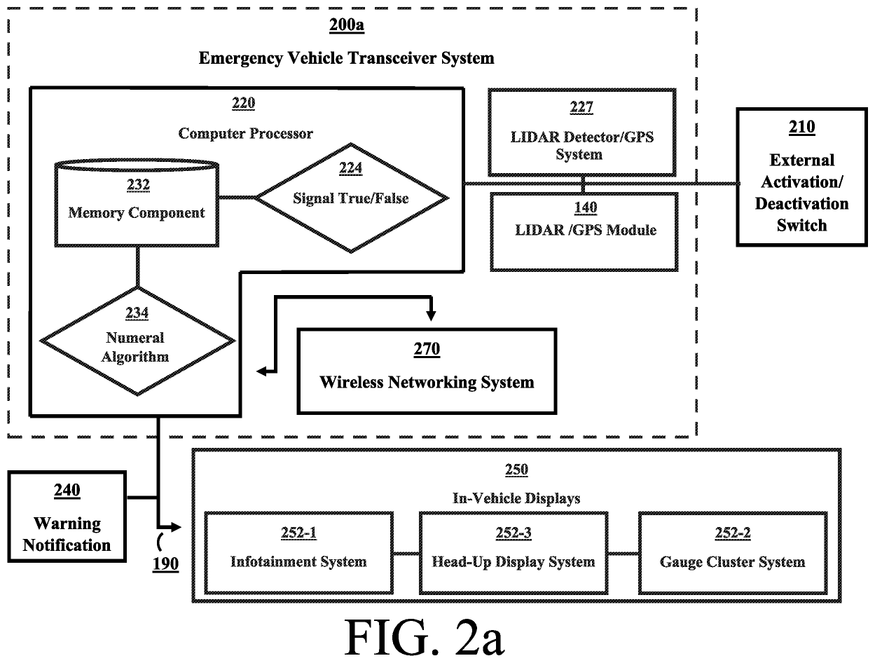

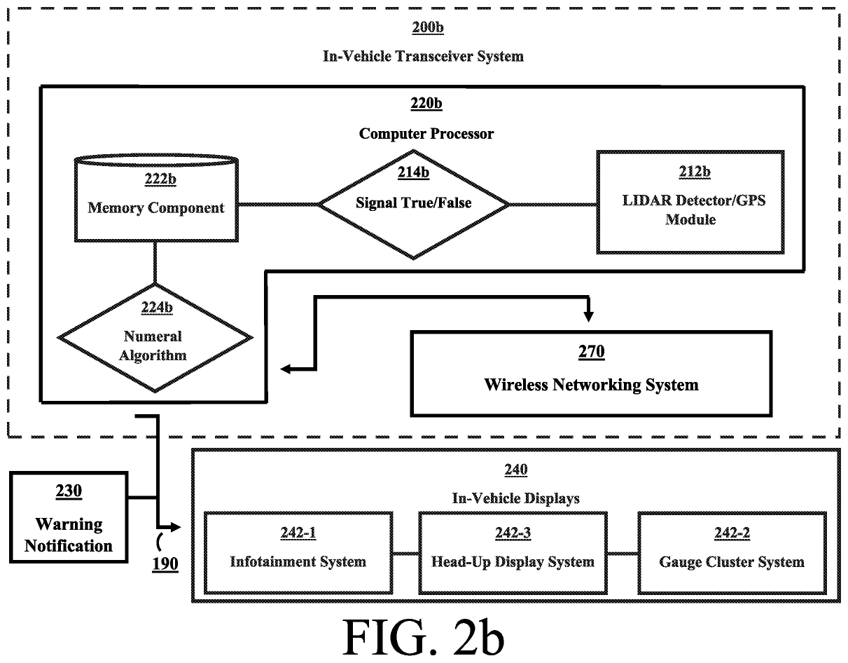

A light detection and ranging system (lidar or LiDAR), which uses light-emitting diodes, can be paired with Global Positioning System (GPS) to generate a detectable communication field 100 for vehicles equipped with an in-vehicle transceiver system (IVTS) 200b, furthermore, the GPS can provide information regarding the location of active emergency vehicles 110, 150. (see FIG. 2 for more information).

The types of receiving vehicles of the lidar communication field 100 can range from vehicles, commuter vehicles, transportation vehicles, commercial vehicles, automobiles 170-1 . . . 170-6, and even other emergency vehicles 110, 150.

Vehicles with an integrated IVTS 200b can detect active lidar communication fields 100 when the receiving vehicles 170-1 . . . 170-6 are within the area of active emergency vehicles 110, 150. Additionally, opposing active emergency vehicles 110, 150 equipped with a suitable emergency vehicle transceiver system EVTS 200a can also detect the lidar communication fields 100 of other emergency vehicles 110, 150 that are active within the vicinity. The GPS-LS 140 can provide information to nearby vehicles 170-1 . . . 170-6 equipped with an IVTS 200b or emergency vehicles 110, 150 equipped with an EVTS 200a information retaining to pre-avoidance warnings of active emergency vehicle's 110, 150 including information such as a general location, street name, and approximate location from other vehicles. Continuously, a computer processor 220 paired with the GPS-LS 140 can provide further details such as the type of emergency vehicle generating the lidar communication field 100.

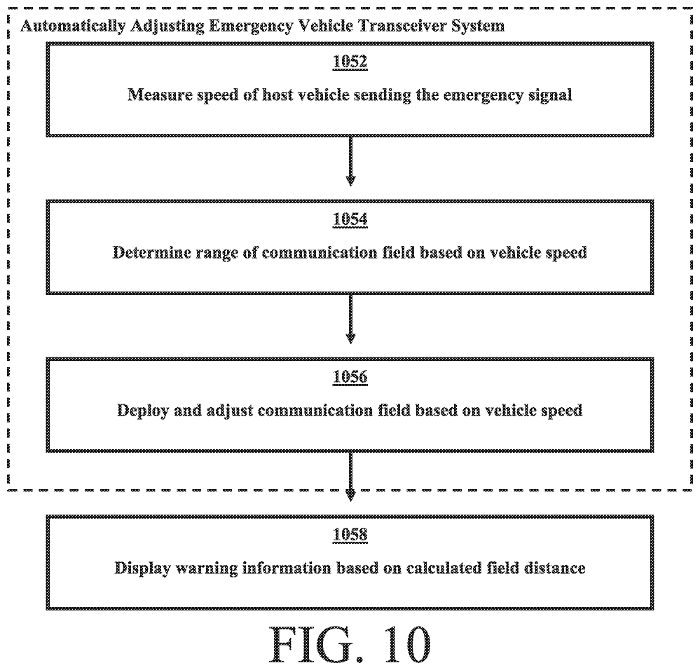

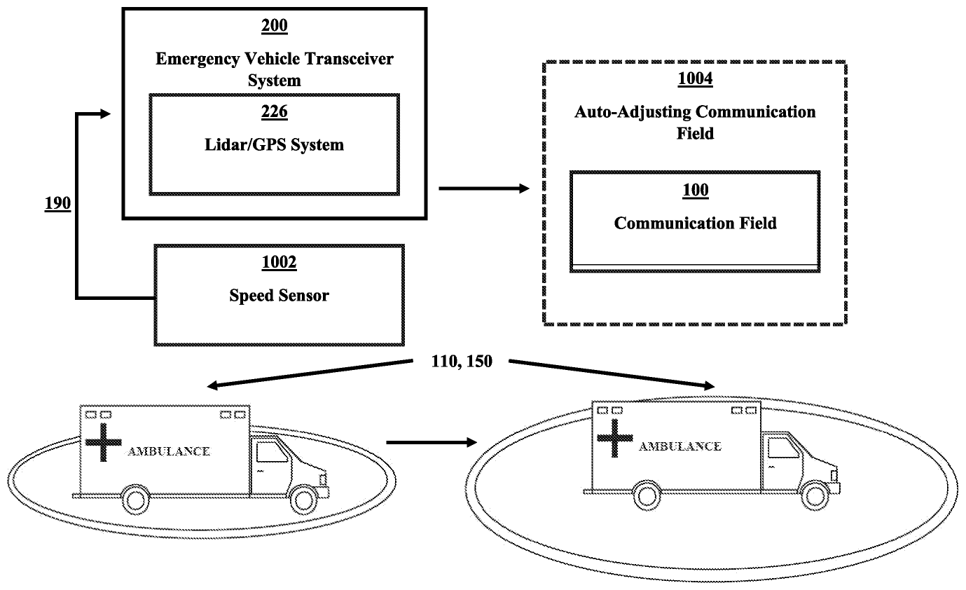

The EVTS 200a integrated within an emergency vehicle 110, 150 can utilize a GPS-LS 226 to create a detectable lidar communication field 100 through a laser light within a suitable and operable lidar system. The EVTS 200a can use a laser light capable of reaching a suitable distance for lower and higher speed driving situations so that IVTS 200b and even other EVTS 200a systems can detect the lidar communication field 100. The radius of the laser light can be adjusted according to the emergency vehicle's 110, 150 speed, or it can alternatively utilize the GPS location (see FIG. 10a and FIG. 10b for more details).

The GPS-LS 140 located within various emergency vehicle types 110, 150 can integrate with the in-vehicle systems via an in-vehicle bus module 190. The bus 190 can bridge the in-vehicle systems together such as the ESM 120-1, in-vehicle UI system 240 (user interactive displays that control the various in-vehicle systems, controls, and functions), and audio systems to provide detailed information about the main invention's functions and statistics to emergency personnel inside the emergency vehicle via an audible tone or sound 110, 150.

Various types of emergency vehicles 150 that can transmit lidar communication fields 100 can include fire trucks, police vehicles (depending on the type of emergency), response vehicles, fast response vehicles, non-transporting EMS vehicles, and fly cars. In reference to FIG. 1, the vehicles have dedicated or specialized versions of the transceiver module 200 to send signals to other nearby emergency vehicles 110, 150, and commuter vehicles 170-1, 170-6. Additionally, the GPS-LS 140 located within police vehicles can have a separate switch mechanism apart from the ESM 120-1 which users can activate in certain emergency situations.

The GPS-LS 140 can integrate with emergency vehicles. The GPS-LS located within emergency vehicles 110, 150 can adjust the radius of the lidar communication field 100 based on the speed of travel or specific location of the emergency vehicle 110, 150 that deploys the lidar communication field 100 based on data provided by the GPS-LS 140.

In addition to the disclosed GPS-LS 140, other alternative systems that can be utilized to bridge communication between emergency vehicles and commuter vehicles, depending on the implementation of the system, are other wireless communication systems such as a radio detection and ranging system (radar or RADAR), wireless local area networking (WLAN), near-field communications (NFC), and cellular networking technologies. Alternatively, the GPS-LS 140 can be further configured to automatically switch from a lidar or LiDAR-based system to a radio detection and ranging system.

FIG. 2a illustrates a flowchart of the architecture and process of an emergency vehicle transceiver system which provides nearby vehicles such as vehicles, transportation vehicles, commuter vehicles, and automobiles as well as personal mobile devices, and can also receive emergency signals from other active emergency vehicles.

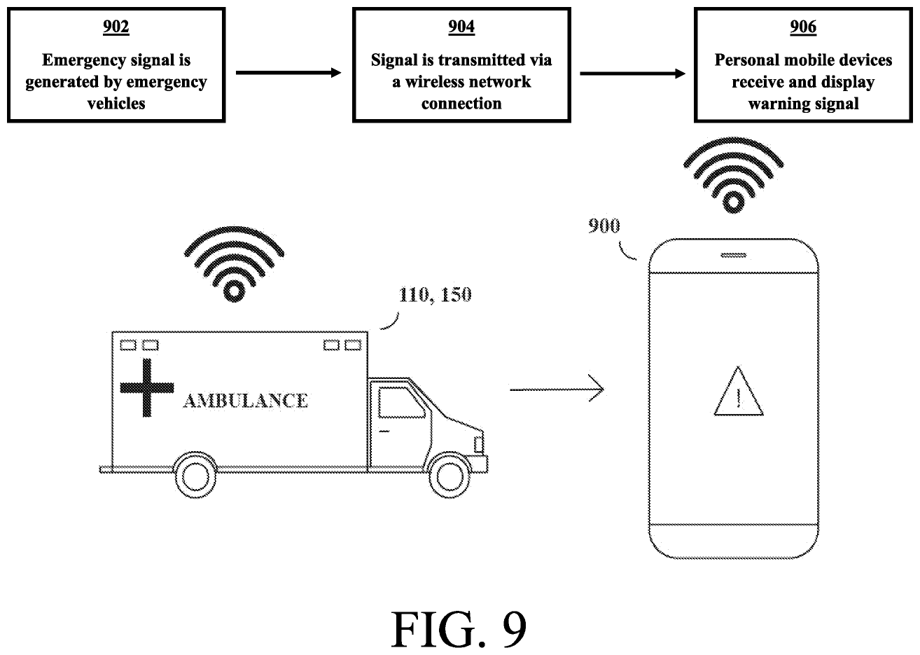

In reference to FIG. 1, FIG. 2b, and FIG. 9, the disclosure highlights the physical layer of EVLABS, an in-vehicle transceiver system (IVTS) 200 located within a vehicle, transportation vehicle, commuter vehicle, automobile 170-1 . . . 170-6. The disclosed embodiment highlights the detection of a lidar communication field 100 generated by active emergency vehicles 110, 150. Detection of a lidar communication field 100 generated by an emergency vehicle 110, 150, the emergency vehicle transceiver system (EVTS) 200a provides an alert signal to the receiving vehicle's IVTS 200 via the lidar detector and GPS module (LD-GPS) 227 onboard computer processor 220 through an in-vehicle bus 190. The computer processor 220 can send a warning notification 240 to the in-vehicle UI system 240 (the physical layer). In-vehicle UI system 240 informs vehicle occupants about oncoming emergency vehicles 110, 150 through the infotainment display 252-1, gauge cluster display 252-2, and the heads-up display 252-3. Additionally, alongside the computer processor 220, a built-in LD-GPS 227 can relay the alert detection to at least one computer processor 220 which can provide warning information 240 to occupants inside a vehicle or automobile 170-1 . . . 170-6 such as the specific type of emergency vehicle, location, estimated distance to approach, and the street location of nearby emergency vehicles and displays the information through the in-vehicle UI system 250 provided by the computer processor 220. Furthermore, the calculated distance of an approaching emergency vehicle compared to their own vehicle 170-1 . . . 170-6 is provided to vehicle occupants in real-time accuracy to inform them of the approaching danger accurately.

Other emergency vehicles 110, 150 can receive warning signals from other nearby active emergency vehicles as well. For instance, an EVTS 200a within an emergency vehicle 110, 150 can operate similarly to the IVTS 200b and detect the lidar communication field 100 from other active EVTS 200 systems.

The types of vehicles that can receive alert signals from emergency vehicles are cars, sedans, sport utility vehicles (SUV), trucks, transportation vehicles, buses, bikes, motorcycles, commercial vehicles, and emergency vehicles such as ambulances, fire trucks, police vehicles, response vehicles, fast response vehicles, non-transporting EMS vehicles, and fly cars.

In addition to the current disclosure thus far, at least one computer processor 220 with an algorithm 214, can determine whether the emergency signals sent by the GPS-LS 140 from emergency vehicles 110, and 150 are false positives or negatives 224. Furthermore, the computer processor 220 can read and provide information from the storage component 222 to vehicle occupants. The storage component 222 comprises information regarding the types of communication signals and the number of times EVLABS is activated in emergency situations. The computer processor 220 also contains a numeral algorithm 224 which can calculate the number of communication signals the IVTS 200 detects and determine the number of emergency vehicles in the area based on the number of lidar communication fields 100 the system processes.

Other physical layers that can provide vehicle occupants with a warning notification 240 are independent or third-party systems integrated with in-vehicle UI systems such as an infotainment display 250 such as an Apple CarPlay™ system by Apple Inc. or an Android Auto™ system by Google (or AutoConnect Holdings LLC). The alternate physical layers also elaborate on personal mobile devices 900 that can utilize wireless connectivity through a wireless network or cellular network and can receive warning notifications 240 from an emergency vehicle equipped with an EVTS 200a. The vehicle or automobile equipped with Bluetooth™ can pair cellular smartphones and other personal mobile devices 900 (See FIG. 9 for more information) through wireless pairing integration. The personal mobile device 900 can display warning information through the in-vehicle UI system 250.

The switch controller module 210 implemented into emergency vehicles 110, 150 for engaging the EVTS 200a can be a physical activation switch or an automatically activated switch interconnected with an emergency vehicle's warning systems.

FIG. 2b illustrates a flowchart of the architecture and process of a vehicle receiving an alert signal via a transceiver module located within a vehicle, transportation vehicle, commuter vehicle, and automobile and providing an alert signal message through various in-vehicle system displays.

The next section, with reference to FIG. 2a, further elaborates on the process of a vehicle or automobile 170-1 . . . 170-6 receiving warning signals from emergency vehicles 110, 150. A distinct transceiver system within vehicles and automobiles 170-1 . . . 170-6 such as an IVTS 200b can work in a similar manner to the EVTS 200a with the omission of a switch control module 210 and a GPS-LS 140. The IVTS 200b can receive warning signals from emergency vehicles 110, 150 equipped with an EVTS 200a and can display warning notifications 240 to in-vehicle UI systems 250 such as an infotainment display, a UI display, gauge cluster display, and a heads-up display.

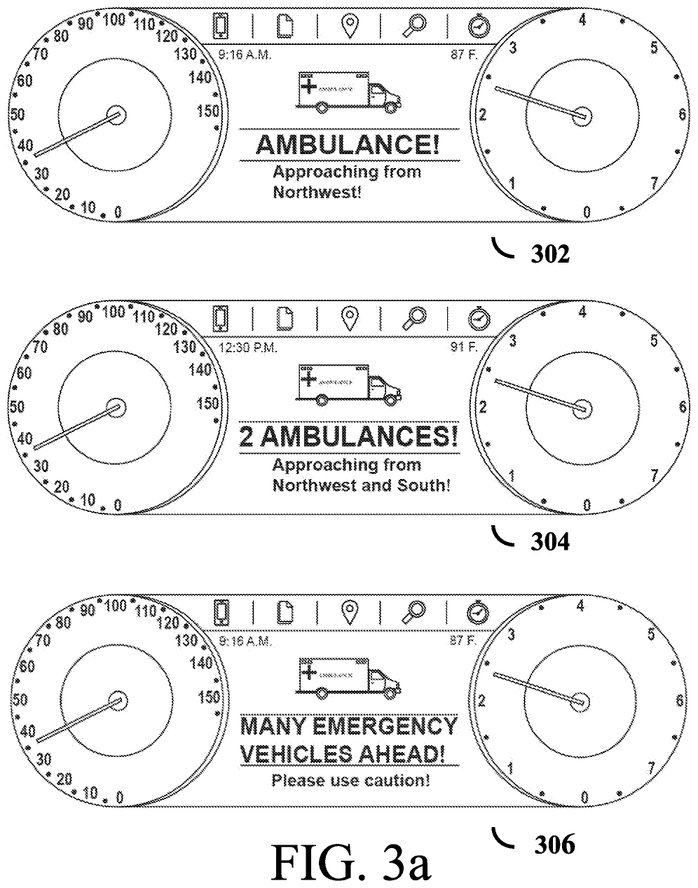

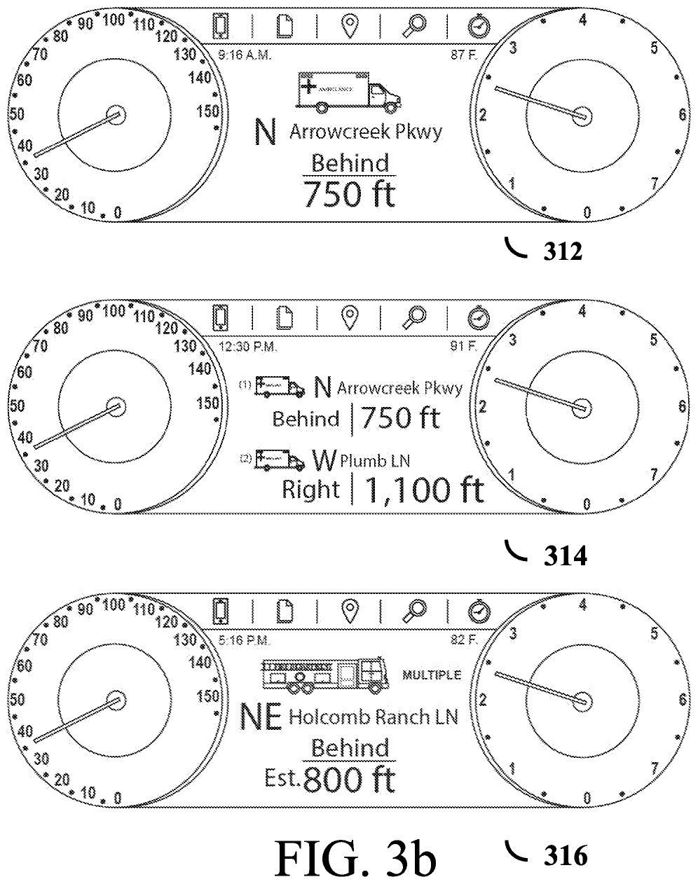

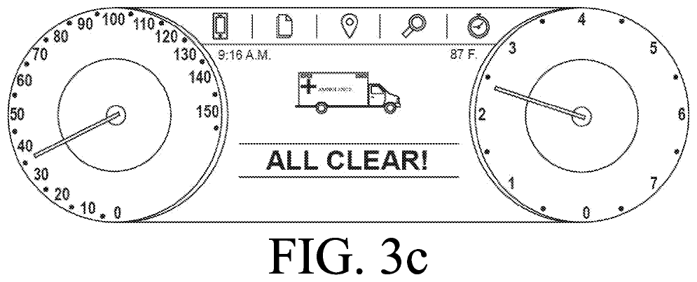

FIGS. 3a, 3b, and 3c highlight diagrams of a gauge cluster system within a vehicle or automobile displaying an alert message from an emergency vehicle(s) that includes the type of emergency vehicle, general direction, and the estimated proximity of an approaching emergency vehicle.

Now referencing FIGS. 1 and 2, FIGS. 3a, 3b, and 3c illustrate the projection of a warning notification 240 through a suitable in-vehicle UI system 250, or more specifically, to the gauge cluster display 252-2 in accordance with the disclosed embodiment which includes the previously mentioned embodiment in FIG. 2. The types of vehicles with interactive gauge cluster displays vary from the types of vehicles and automobiles 170-1 . . . 170-6 and emergency vehicles 110, 150 equipped with the technology. A bus module 190 can connect to in-vehicle UI systems 250 from the EVTS 200a and IVTS 200b respectively. The computer processor 220 of the EVTS 200a and IVTS 200b can provide warning notifications 240 based on lidar communication fields 100 detected by the LD-GPS 227 of both transceiver systems. The gauge cluster display 252-2 displays warning notifications 240 of an approaching emergency vehicle 110, 150 based on the detection of an emergency vehicle's 110, 150 lidar communication field 100 through the LD-GPS 212 integrated into the vehicle or automobile 170-1 . . . 170-6. The LD-GPS 212 can detect a lidar communication field 100, and the IVTS 200b generates a warning notification to the gauge cluster display 252-2 through three transitional screens: the first of these screens according to FIG. 3a is a preliminary alert notification displayed through the gauge cluster display 252-2 that warns vehicle occupants that an active emergency vehicle has been detected, located within proximity, and heading near the receiving vehicle's direction alongside the cardinal direction such as north, south, west, and east (the location of the emergency vehicle is relative to the direction of the lidar communication field 100 is detected); in FIG. 3b, the second alert message presents the calculated distance of the oncoming emergency vehicle, a GPS-based location of the emergency vehicle, the number of active emergency vehicles in the given area, and a general direction of the emergency vehicle which can be from ahead, behind, to the left, and to the right of the receiving vehicle's location; and finally, FIG. 3c discloses that the receiving vehicle 170-1 . . . 170-6, 110, and 150 of the alert notification has cleared all active emergency vehicles within the area.

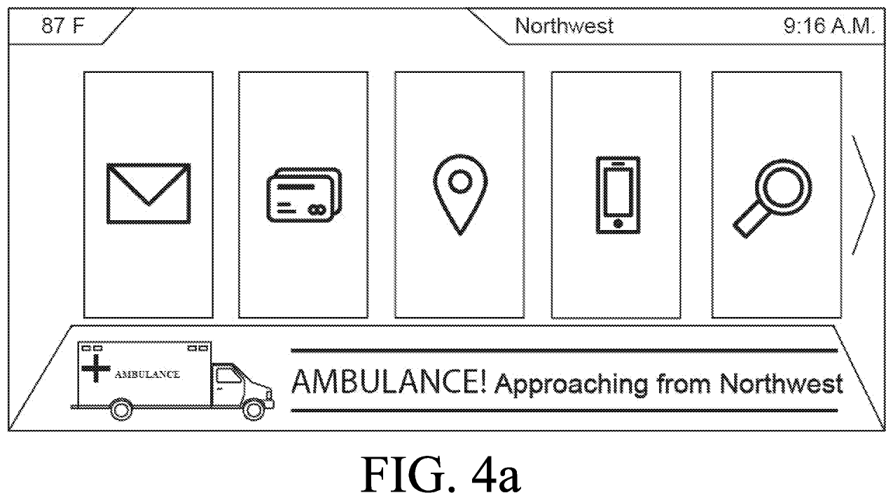

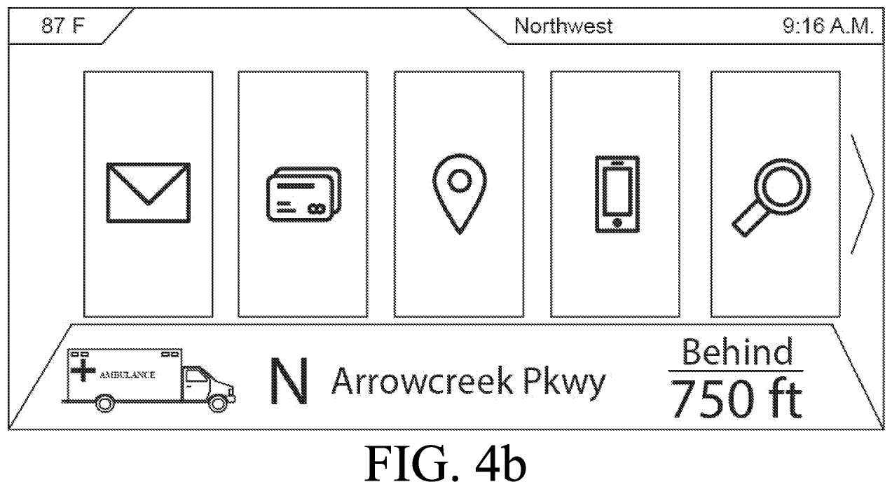

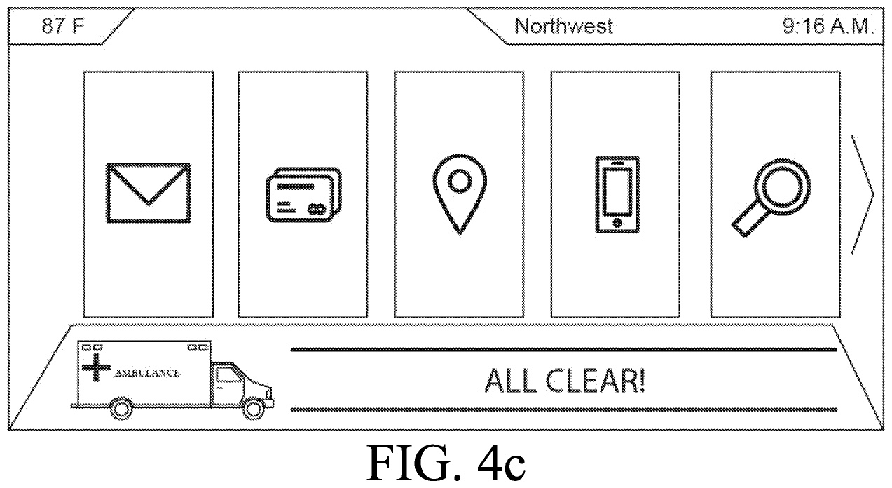

FIGS. 4a, 4b, and 4c highlight a warning signal displayed through an infotainment display system within a vehicle or automobile that includes the type of emergency vehicle and the general direction emergency vehicles are heading.

As similarly disclosed in FIG. 1, FIG. 2, FIGS. 3a, 3b, and 3c, FIG. 4a, 4b, 4c are illustrations of an infotainment display 252-1 within a vehicle or automobile highlighting warning information about oncoming emergency vehicles 110, 150. The figure follows the same design disclosed in FIGS. 3a, 3b, and 3c, yet it serves to further explain the elements, features, and processes shown in the current embodiment. The process of projecting a warning notification 240 through the infotainment system takes place when the EVTS 200a or IVTS 200b detects the lidar communication field 100 generated by emergency vehicles 110, 150 and displays the contents of oncoming emergency vehicles through the in-vehicle UI system 240. The infotainment display 252-1, which is a sub-component of the in-vehicle UI system 250, projects warning notifications 240 of approaching emergency vehicles 110, 150.

The process of projecting the contents of a warning notification 240 to the infotainment display 252-1 follows a similar architecture as the gauge cluster display 252-2 as illustrated in figures FIGS. 3a, 3b, and 3c apart from the potential of utilizing an altered layout format for projecting contents provided by the warning notification 240. The first projection, in accordance with FIG. 4a, is a preliminary warning notification 240 of an approaching emergency vehicle 110, 150 which informs vehicle occupants of the emergency vehicle's general location, emergency vehicle type, and the cardinal direction such as north, south, west, and east. The second projection, according to FIG. 4b, is an infotainment display 252-1 providing vehicle occupants the estimated distance of approaching emergency vehicles 110, 150 compared to the receiving vehicle, the number of active emergency vehicles 110, 150 in the receiving vehicle's location, a GPS-based street location of the emergency vehicle, and a general direction such as to the left, right, behind, and ahead; the third projection as illustrated in FIG. 4c is a final message screen that informs vehicle occupants that any/all emergency vehicles are clear of the receiving vehicle's proximity.

On a separate note, along with the visual warning notifications 240 that are displayed through the infotainment system 252-1, the alert signal notification 240 can have an audial alert chime that alerts vehicle occupants of oncoming emergency vehicles 110, 150. Both emergency vehicles 110, 150 and civilian vehicles or automobiles 170-1 . . . 170-6 can be the recipients of the audial alert chimes. The alert chime can sound through various in-vehicle audio sources such as the speakers, audio system, and other suitable speaker locations. The alert chime can be triggered when the EVTS 200a and the IVTS 200b detect the active lidar communication fields 100 generated by approaching emergency vehicles 110, 150.

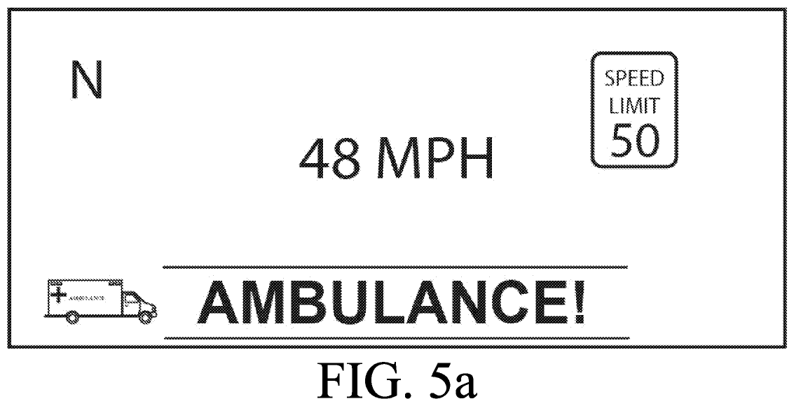

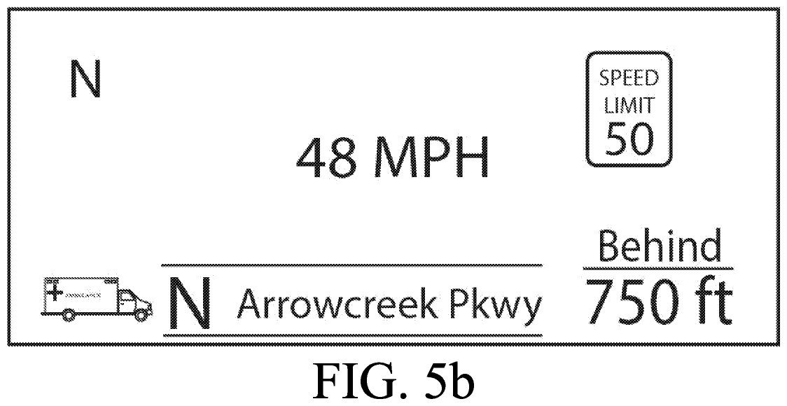

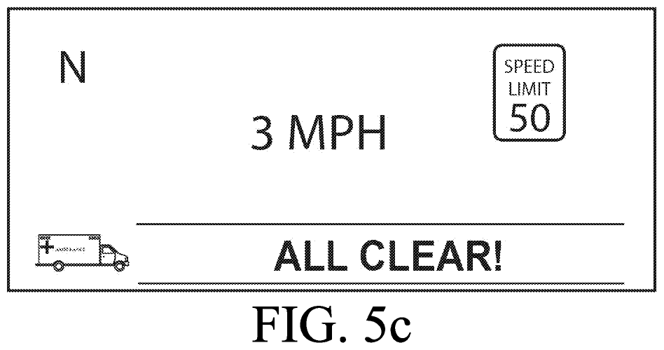

FIGS. 5a, 5b, and 5c highlight block diagrams of a heads-up display system within a vehicle or automobile displaying an emergency vehicle(s) approximate distance, the street location, the type of emergency vehicle it is, the number of emergency vehicles, and a general direction.

FIGS. 5a, 5b, and 5c, with reference to the previously disclosed figures, are illustrations of a heads-up display system 252-3 within a vehicle or automobile that relays information about oncoming emergency vehicles to the driver. The disclosed sub-systems of EVLABS (the main disclosed invention) provide information about emergency vehicles via a bus module 190 to the in-vehicle UI system 250 which then displays the information through the heads-up display system 252-3. Following the same procedures of operation as the components and sub-components disclosed in the previous figures, according to the main disclosure, FIG. 5a is a block diagram of a heads-up display system 252-3 providing the driver with preliminary warnings of approaching emergency vehicles including a general direction of the vehicle's heading. FIG. 5b illustrates further the process of relaying emergency vehicle 110, 150 information to the driver with includes information such as the number of emergency vehicles active in the given area, a GPS-assisted street location, the calculated distance to approach, and the type of emergency vehicle sending the alert signal. Finally, FIG. 5c is a block diagram of a heads-up display system 242-3 communicating to the driver that their vehicle has cleared all active emergency vehicles 110, 150 in the area.

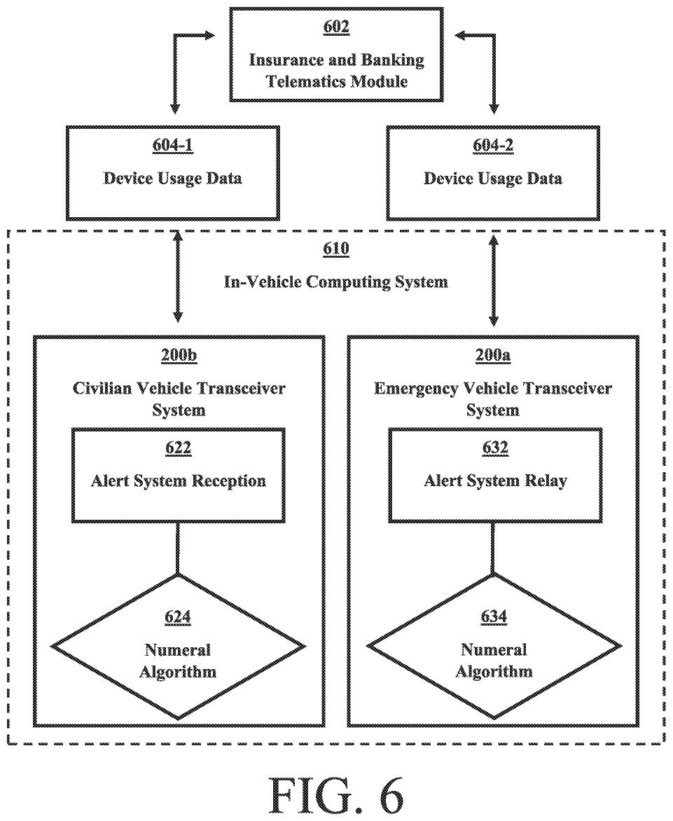

FIG. 6 highlights a flow chart of a banking and insurance telematics module integrated within a vehicle or automobile receiving device activation data based on the number of times the disclosed subject matter is activated.

Referring now to FIGS. 1 and 2, FIG. 6 is a flowchart of a telematics module located in both commuter vehicles and emergency vehicles which calculates the number of times the main disclosed invention is activated as shown according to the disclosed embodiment. The insurance and banking telematics system (IBTS) 602 is a device that is a sub-component of the main disclosed invention located within a vehicle, transportation vehicle, commuter vehicle, automobile, or emergency vehicle that monitors and collects device usage data 604 generated by the disclosed embodiment and sends the data to insurance and banking companies for the purpose of providing benefits to EVLABS users.

Furthermore, the IBTS 602 collects data about the IVTS 200b and EVTS 200a provided by the computing processor 610 such as the number of times CVTS 620 and EVTS 630 are activated in emergency situations. The computing system 610 provides device usage data 604-1, 604-2 to the IBTS 602 which can be sent to insurance or banking companies. In the vehicle or automobile 170-1 . . . 170-6 with a computing processor 610 that can integrate with an IVTS 200b, the numeral algorithm 624 can determine the number of times the alert system reception 622 activates in the event of an emergency vehicle detection by the IVTS 200b. In a similar method, the EVTS 200a integrated into emergency vehicles can determine the number of times the alert system relay 632 is activated via a numeral algorithm 634.

The IBTS 602 can additionally send information to banks and insurance companies through a wireless cloud-based network system, cellular network system, local area network (LAN), or wireless local area network (WLAN).

In an additional embodiment, IBTS 602 can be integrated with the main head units IVTS 200a and EVTS 200b respectively through various in-vehicle systems and connector modules such as a bus connector or other alternative connection points. The computer processor integrates IBTS 602 and the rest of the disclosed components together respectively by combining the computer with the IBTM 602 through a port module such as an OBD or OBD-II port located within a vehicle or automobile for example.

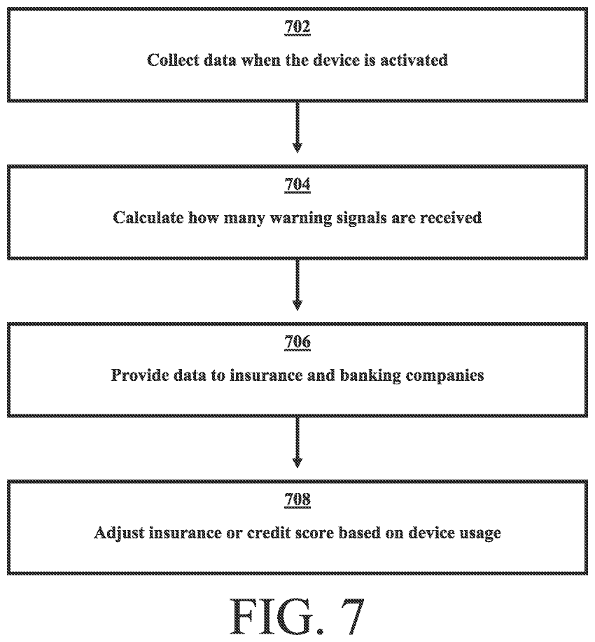

FIG. 7 highlights a flowchart that further illustrates the architectural framework of the banking and insurance telematics module within a vehicle or automobile as it relates to insurance and banking incentives.

The next disclosure references FIG. 6, FIG. 7 which represents a flowchart demonstrating the process of transmitting device usage information from emergency vehicles and commuter vehicles or automobiles to insurance or banking companies. Data provided by the in-vehicle computer processor 610 processes through the IBTS 602 and is sent to insurance or banking companies via over-the-air connection methods such as a cloud-based network, cellular network, and a wireless local area network (WLAN). Companies can use data provided by the IBTS 602 to incentivize insurance benefits which reward drivers and first responders for keeping the disclosed invention activated in their vehicles or automobiles.

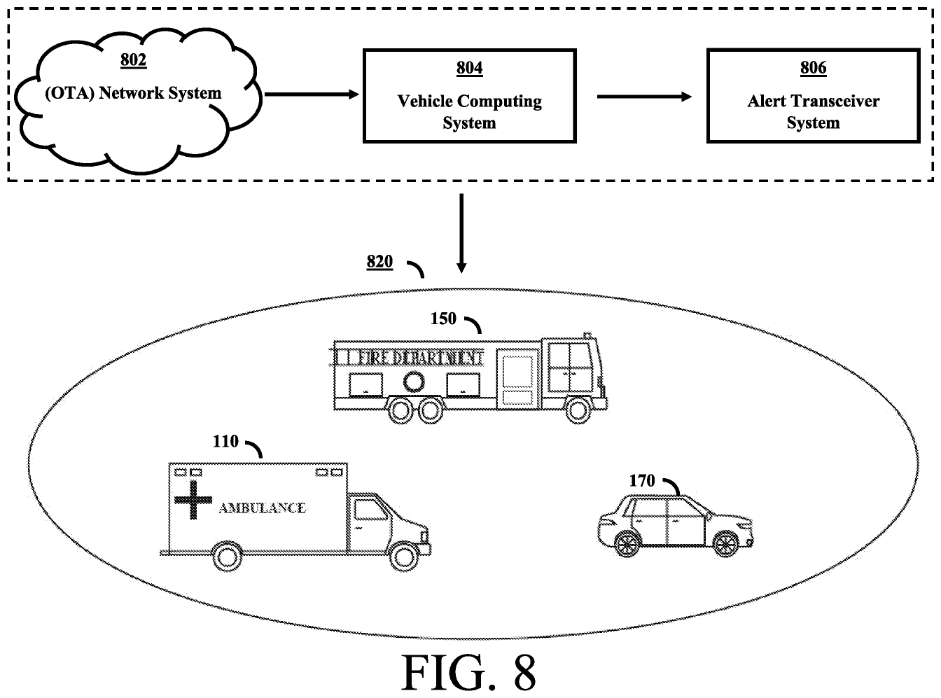

FIG. 8 highlights a flow diagram of a cloud-based network system that provides software updates to the disclosed invention.

The specimen is a cloud-based network system integrated with the main invention in commuter vehicles or automobiles and is also located in emergency vehicles. The system provides updates to features and functions of EVLABS and can function as a method to employ other various functions for purposes not explicitly disclosed within the document.

With reference to FIGS. 1 . . . 7, FIG. 8 showcases a network of vehicles 820, vehicles or automobiles 170, and all types of emergency vehicles 110, 150 that can receive updates through an OTA network system 802 that pairs with a vehicle computing system 804 linked to a vehicle's alert transceiver system 806. The network of vehicles or automobiles 820 can receive enhancements to features and functions that can further improve the quality of the main invention and add new features through the (OTA) network system 802.

FIG. 9 highlights a flow diagram of personal mobile devices capable of connecting with a wireless network to receive warning signals from oncoming active emergency vehicles and communicate warning signal information to users.

Finally, with reference to the previously disclosed figures, FIG. 9 discloses a sub-component of EVLABS which is the connection between emergency vehicles 110, 150 and personal mobile devices 900 through a wireless networking system. Personal mobile devices 900 capable of connecting to a wireless network can receive alert signals generated by the in-vehicle transceiver 200 located in emergency vehicles 110, 150 of the various types previously disclosed.

Furthermore, the wireless network system 270 sub-component integrated into an emergency vehicle 110, 150 can provide people with a personal mobile device 900 warning information about oncoming emergency vehicles 110, 150 with a similar purpose to the in-vehicle UI system 250 (more details about FIG. 9 will be mentioned further in this document).

The differing types of personal mobile devices 900 such as cellular phones, smartphones, tablets, personal computers, and laptops have integrated wireless connectivity and networking technologies built into the devices from the manufacturer. The personal mobile devices 900 can receive information from emergency vehicles 110, 150 through wireless connections such as Bluetooth™, near-field communications (NFC), wireless local area networking (WLAN) cellular networking, GPS, and other forms of wireless connectivity. Personal mobile devices 900 can receive warning information about oncoming emergency vehicles with at least one of the mentioned types of wireless connection systems 270 integrated with an EVTS 200a IVTS 200b. Furthermore, a dedicated mobile application designed specifically for the invention can provide warning information retaining to nearby emergency vehicles 110, 150 and, in an additional embodiment, the invention can operate similarly to amber alerts produced from personal mobile devices 900.

FIG. 10a represents a flow diagram of an emergency vehicle transceiver creating a lidar field that can be adjusted according to the emergency vehicle's speed of travel or location.

Finally, with reference to the previously disclosed figures, an emergency vehicle 110, 150 with an integrated and operable IVTS 200 can reactively calculate and adjust the radius of the lidar communication field 100 it produces based on the speed of travel or GPS location of the active emergency vehicle 110, 150 as FIG. 10 demonstrates. The purpose of an auto speed adjuster module (ASAM) 1004 is to provide vehicle occupants with enough time to react to potentially hazardous encounters with oncoming active emergency vehicles 110, 150 regardless of the speed of the approaching emergency vehicle 110, 150 and the defending vehicles, transportation vehicles, commuter vehicles, or automobiles 170-1 . . . 170-6. For instance, an emergency vehicle 110, 150 traveling around seventy-five miles per hour can provide the same amount of time for defending vehicles, transportation vehicles, commuter vehicles, and automobiles 170-1 . . . 170-6 to react to oncoming emergency vehicles 110, 150 because of a wider level of lidar communication field 100 range coverage at higher speeds.

In an alternative embodiment, the GPS-LS 226 can utilize route information to trigger the ASAM 1004 to widen or shorten the range of the lidar communication field 100 based on the GPS location of the emergency vehicle 110, 150.

The EVTS 200a which can produce a lidar communication field 100 can auto-adjust the field range by detecting the emergency vehicle's 110, 150 speeds, as illustrated in the flow diagram. The EVTS 200a can process the speed of the moving emergency vehicle 110, 150 via ASAM 1004 provided by a bus module 170 connected to the speed sensor 1002 attached to the emergency vehicle's 110, 150 transmission or drivetrain. The speed sensor 1002 can trigger a response from the transceiver to increase the lidar communication field 100 range if the emergency vehicle 110, 150 increases speed. The speed sensor 1002 can provide speed information to the computer processor 220 via a bus 190 which the GPS-LS 226 can utilize to increase and decrease the range of the lidar communication field 100.

FIG. 10b further illustrates the procedures of an auto-adjusting lidar communication field in the event of an emergency vehicle 110, 150 changing its speed or location. The embodiment merely demonstrates in further detail how, in the event of an emergency vehicle 110, 150 changing its direction or speed of travel, the GPS-LS 226 can create a larger or smaller bandwidth depending on the variables previously mentioned.

All figures, details, designs, embodiments, functions, and features of the disclosed invention are present. While the design and scope of the invention, provided by the illustrations, drawings, flowcharts, and flow diagrams are presented for the purpose of demonstrating the process, design, functions, and features, they do not completely limit the potential for future enhancements, updates, and revisions. Improvements can be made to the invention without limiting its scope and purpose outside of the claims. In adherence to the provided disclosures of the detailed descriptions of figures, the following section will highlight the claims of the disclosed invention which further expands upon the functions, processes, components, and details of the disclosed specimen.

What is claimed in this document is:

1. An apparatus in an emergency vehicle that provides early warning information of nearby or oncoming active emergency vehicles to transportation vehicles, commuter vehicles, automobiles, other nearby emergency vehicles, and personal mobile devices via a detectable warning signal which comprises of:
a transceiver module in an emergency vehicle that provides warning signals to nearby transportation vehicles, commuter vehicles, automobiles, other emergency vehicles, and personal mobile devices; and
can also receive warning signals from other active emergency vehicles with an integrated transceiver.
A GPS/lidar component integrated with the transceiver module provides emergency vehicle information to personal mobile devices and in-vehicle UI systems.
a computer processor integrated with the transceiver module that can detect warning signals produced by emergency vehicles, and
calculate the number of active emergency vehicles based on the number of active warning signals.
a wireless networking system that provides warning information to personal mobile devices and other devices capable of utilizing a wireless network or cellular network.
a switch module integrated into emergency vehicles that can be activated physically or automatically to activate the transceiver.

2. The computer-implemented method of claim 1, wherein the transceiver utilizes integrated radio frequency technologies such as lidar to create a detectable communication field that functions as a warning signal for nearby commuter vehicles, automobiles, other emergency vehicles, and personal mobile devices.

3. An apparatus of claim 1, wherein the functionality of the transceiver and computer processor further comprises of:
distinguishing numerous types of radio frequencies produced by various radio frequency bands within a nearby radius,
determining false positive/negative radio frequency signals from differing bands, and
providing a GPS location of active emergency vehicles producing the correct lidar emergency signal.

4. An apparatus of claim 1, wherein the transceiver utilizes mobile networking technologies to provide personal mobile devices, commuter vehicles, automobiles, and other emergency vehicles alert signals of nearby or oncoming active emergency vehicles within the vicinity.

5. An apparatus of claim 1, wherein the computer processor can relay warning signals to personal mobile devices via a wireless networking system that utilizes a cellular network or wireless network.

6. An apparatus of claim 1, wherein the transceiver is further operable to identify the types of lidar signals produced by emergency vehicle transceivers, and
relaying warning signals to the computer processor within a vehicle.

7. The method of claim 6, wherein a bus connector transmits emergency vehicle information from the computer processor to the in-vehicle UI system such as a user interface display, heads-up display, gauge cluster display, or infotainment system.

8. The computer-implemented method of claim 1 wherein in-vehicle UI systems such as an in-vehicle display unit, infotainment system, heads-up display, and gauge cluster display can provide detailed early warning information about active emergency vehicles approaching the vicinity provided by a GPS system.

9. The computer-implemented method of claim 8 wherein the computer processor can provide personal mobile devices and in-vehicle UI systems such as an in-vehicle display unit, infotainment system, heads-up display, and gauge cluster display the whereabouts of emergency vehicles via such as the street name and location.

10. The computer-implemented method of claim 8, further comprising the computer processor can provide personal mobile devices and in-vehicle UI systems such as an in-vehicle display unit, infotainment system, heads-up display, and gauge cluster display the location of emergency vehicles in relation to the receiving vehicle or personal mobile device of the lidar warning signal via an estimated numerical value in metrics or customary units.

12. The computer-implemented method of claim 8, further comprising the computer processor can provide personal mobile devices and in-vehicle UI systems such as an in-vehicle display unit, infotainment system, heads-up display, and gauge cluster display a general direction of emergency vehicles such as to the north, south, west, and to the east.

13. The computer-implemented method of claim 8, further comprising the computer processor can provide personal mobile devices and in-vehicle UI systems such as an in-vehicle display unit, infotainment system, heads-up display, and gauge cluster display the number of active emergency vehicles within the area.

14. The method of claim 8, which further comprises the computer processor can provide personal mobile devices and in-vehicle UI systems such as an in-vehicle display unit, infotainment system, heads-up display, and gauge cluster display an audial warning chime through when an active emergency vehicle is detected by the transceiver.

15. The method of claim 8, which further comprises the computer processor can provide personal mobile devices and in-vehicle UI systems such as an in-vehicle display unit, infotainment system, heads-up display, and gauge cluster display an all-clear warning when active emergency vehicles have cleared the area.

16. The apparatus of claim 1, wherein a wireless cloud-based networking system that provides over-the-air updates to the transceiver and computer processor.

17. The apparatus in a commuter vehicle, transportation vehicle, and automobile that detects active warning signals produced by emergency vehicles to provide early warning information of nearby or oncoming active emergency vehicles to vehicle occupants which comprises of:
a transceiver module that detects lidar warning signals from emergency vehicles; and
can also receive warning signals from other active emergency vehicles with an integrated transceiver.
A GPS/lidar component integrated with the transceiver module that provides emergency vehicle information to in-vehicle UI systems.
a computer processor integrated with the transceiver module that can detect warning signals produced by emergency vehicles, and
calculate the number of active emergency vehicles based on the number of active warning signals.

18. The apparatus of claim 17, wherein the transceiver utilizes integrated radio frequency detection technologies to detect lidar communication fields produced by emergency vehicles.

19. An apparatus of claim 17, further comprising:
the identification of the type of lidar signal produced by emergency vehicle transceivers and, relay warning signals to the computer processor.

20. An apparatus of claim 17, wherein the functionality of the transceiver and computer processor further comprises:
distinguishing numerous types of radio frequencies produced by various radio frequency bands within a nearby radius,
recognizing false positive/negative radio frequency signals from differing bands, and
providing a GPS location of active emergency vehicles producing the correct lidar emergency signal.

21. The apparatus of claim 17, wherein the transceiver can distinguish the type of communication signal produced by emergency vehicle transceivers and relay warning notifications to in-vehicle UI systems such as an infotainment display, user interface display, a gauge cluster display, and a heads-up display via the computer processor.

22. The apparatus of claim 21, wherein a bus connector transmits emergency vehicle information from the computer processor to the in-vehicle UI system such as a user interface display, heads-up display, gauge cluster display, or infotainment system.

23. The computer-implemented method of claim 17 wherein in-vehicle UI systems such as an in-vehicle display unit, infotainment system, heads-up display, and gauge cluster display can provide detailed early warning information about active emergency vehicles approaching the vicinity provided by a GPS system.

24. The computer-implemented method of claim 23 wherein the computer processor can provide personal mobile devices and in-vehicle UI systems such as an in-vehicle display unit, infotainment system, heads-up display, and gauge cluster display the whereabouts of emergency vehicles via such as the street name and location.

25. The computer-implemented method of claim 23, further comprising the computer processor can provide personal mobile devices and in-vehicle UI systems such as an in-vehicle display unit, infotainment system, heads-up display, and gauge cluster display the location of emergency vehicles in relation to the receiving vehicle or personal mobile device of the lidar warning signal via an estimated numerical value in metrics or customary units.

26. The computer-implemented method of claim 23, further comprising the computer processor can provide personal mobile devices and in-vehicle UI systems such as an in-vehicle display unit, infotainment system, heads-up display, and gauge cluster display a general direction of emergency vehicles such as to the north, south, west, and to the east.

27. The computer-implemented method of claim 23, further comprising the computer processor can provide personal mobile devices and in-vehicle UI systems such as an in-vehicle display unit, infotainment system, heads-up display, and gauge cluster display the number of active emergency vehicles within the area.

28. The method of claim 23, which further comprises the computer processor can provide personal mobile devices and in-vehicle UI systems such as an in-vehicle display unit, infotainment system, heads-up display, and gauge cluster display an audial warning chime through when an active emergency vehicle is detected by the transceiver.

29. The method of claim 23, which further comprises the computer processor can provide personal mobile devices and in-vehicle UI systems such as an in-vehicle display unit, infotainment system, heads-up display, and gauge cluster display an all-clear warning when active emergency vehicles have cleared the area.

30. A telematics system for gathering telemetry data from vehicles equipped with a transceiver and computer processor comprising of:
receiving of telemetry data from the number of times the transceiver in an emergency vehicle, transportation vehicle, commuter vehicle, and automobile activates in an emergency, and
transmitting telemetry data to insurance and banking companies through a bus module to a wireless networking system.

31. The apparatus of claim 30, wherein the telematics is an integrated unit with the transceiver module.

32. The method of claim 17, wherein a wireless cloud-based networking system that provides over-the-air updates to the transceiver and computer processor.

30. An apparatus for increasing and decreasing the range of a lidar communication field which comprises of:
an electronic speed sensor module attached to an emergency vehicle's drivetrain that detects the moving vehicle's speed, and
a bus connector that provides speed data to the GPS/lidar system.
